(19) United States
(12) Patent Application Publication
(10) Pub. No.: US 2013/0168559 A1
(43) Pub. Date: Jul. 4, 2013

(54) RADIATION DETECTION APPARATUS

(71) Applicant: CANON KABUSHIKI KAISHA, Tokyo (JP)

(72) Inventors: Shoshiro Saruta, Tokyo (JP); Satoshi Okada, Tokyo (JP); Kazumi Nagano, Honjo-shi (JP); Keiichi Nomura, Honjo-shi (JP); Yohei Ishida, Honjo-shi (JP); Yoshito Sasaki, Honjo-shi (JP); Tomoaki Ichimura, Kitamoto-shi (JP)

(73) Assignee: CANON KABUSHIKI KAISHA, Tokyo (JP)

(21) Appl. No.: 13/710,613

(22) Filed: Dec. 11, 2012

(30) Foreign Application Priority Data
Dec. 28, 2011 (JP) 2011-289889

(51) Int. Cl. G01T 1/20

(52) U.S. Cl. CPC G01T 1/2006
USPC 250/366

(57) ABSTRACT

A radiation detection apparatus including a sensor panel which includes a plurality of pixels two-dimensionally arranged on a substrate and detects light, and a scintillator layer which is disposed on the sensor panel and converts radiation into light, the apparatus, comprising members embedded in regions between the plurality of pixels in the scintillator layer, wherein the member satisfies a relationship of μ_{X}≧μ_{S} where μ_{X} is a linear attenuation coefficient of the member and μ_{S} is a linear attenuation coefficient of a material forming the scintillator layer, contains a material whose light emission amount is smaller than that of the scintillator layer when the radiation enters, and gradually decreases in width from an upper surface to a lower surface.

### BACKGROUND OF THE INVENTION

1. Field of the Invention

The present invention relates to a radiation detection apparatus.

2. Description of the Related Art

A radiation detection apparatus includes a sensor panel which detects light and a scintillator layer which converts radiation into light. The sensor panel includes a plurality of pixels two-dimensionally arranged on a substrate. The scintillator layer can be disposed on the sensor panel. When radiation which has obliquely entered the scintillator layer in the region of a pixel and reached the region of another pixel (for example, an adjacent pixel) is converted into light, signals mix with each other between the pixels. This can lead to a decrease in resolution. For example, Japanese Patent Laid-Open No. 2004-151007 discloses a structure in which a scintillator layer is divided in pixels by using partitions including members which absorb X-rays. This structure can prevent radiation which has obliquely entered the scintillator layer in the region of each pixel from reaching the region of another pixel.

It is more preferable for the radiation detection apparatus to efficiently detect, in each pixel, light generated in the scintillator layer while preventing radiation from entering adjacent pixels.

### SUMMARY OF THE INVENTION

The present invention provides a radiation detection apparatus which is effective in efficiently detecting light generated in the scintillator layer while preventing radiation from entering adjacent pixels.

One of the aspects of the present invention provides a radiation detection apparatus including a sensor panel which includes a plurality of pixels two-dimensionally arranged on a substrate and detects light, and a scintillator layer which is disposed on the sensor panel and converts radiation into light, the apparatus comprising members embedded in regions between the plurality of pixels in the scintillator layer, wherein the member satisfies a relationship of μ_{X}≧μ_{S} where μ_{X} is a linear attenuation coefficient of the member and μ_{S} is a linear attenuation coefficient of a material forming the scintillator layer, contains a material whose light emission amount is smaller than that of the scintillator layer when the radiation enters, and gradually decreases in width from an upper surface to a lower surface.

Further features of the present invention will become apparent from the following description of exemplary embodiments with reference to the attached drawings.

### BRIEF DESCRIPTION OF THE DRAWINGS

FIGS. 1A to 1C are views for explaining an example of the arrangement of a radiation detection apparatus 31 according to the first embodiment;

FIG. 2 is a view for explaining an example of a method of designing the radiation detection apparatus 31;

FIGS. 3A to 3F are views each for explaining an example of the layout pattern of members 3 in the radiation detection apparatus 31;

FIG. 4 is a view for explaining an example of a method of designing the radiation detection apparatus 31;

FIG. 5 is a view for explaining an example of a method of designing the radiation detection apparatus 31;

FIG. 6 is a view for explaining an example of a plan view of the radiation detection apparatus 31;

FIG. 7 is a view for explaining an example of a photomask for forming the members 3;

FIGS. 8A to 8C are views each for explaining the shape of the member 3; and

FIG. 9 is a view listing parameters in the respective embodiments and evaluation results.

### DESCRIPTION OF THE EMBODIMENTS

### First Embodiment

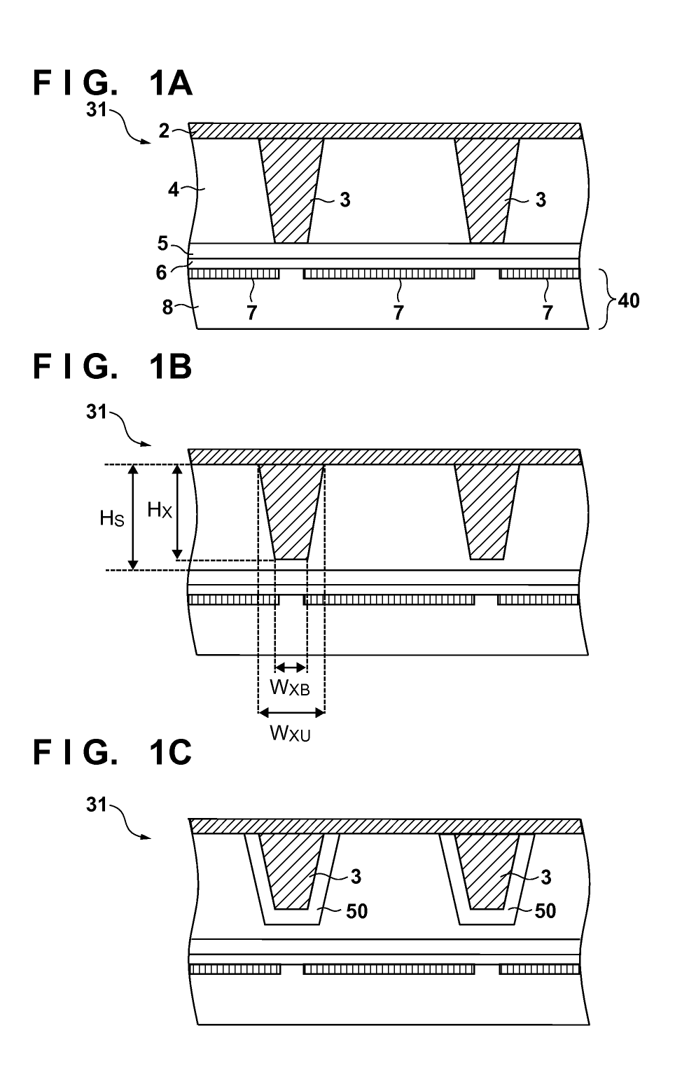

A radiation detection apparatus 31 according to the first embodiment will be described with reference to FIGS. 1A to 9. As exemplified by FIG. 1A, the radiation detection apparatus 31 includes a sensor panel 40 and a scintillator layer 4. The scintillator protection layer 40 includes a plurality of pixels (including photoelectric conversion units 7) two-dimensionally arranged on a substrate 8, and detects light. The scintillator layer 4 is disposed on the scintillator protection layer 40 and converts radiation into light. The radiation detection apparatus 31 includes members 3 embedded in the regions between a plurality of pixels in the scintillator layer 4. Each member 3 contains a material absorbing radiation, and can prevent radiation which has obliquely entered the scintillator layer in the region of each pixel from propagating straight to the region of another pixel.

The radiation detection apparatus 31 can further include a passivation layer 6 and a protection layer 5 disposed on the passivation layer 6 between the scintillator protection layer 40 and the scintillator layer 4. The protection layer 5 can protect the photoelectric conversion units 7 against chemical influences from an external environment. The passivation layer 6 can protect the photoelectric conversion units 7 against physical influences from an external environment. The radiation detection apparatus 31 can include a base 2 disposed to cover the scintillator layer 4 and the members 3.

The radiation (typically X-rays) transmitted through the body of an object enters from the upper surface A side of the radiation detection apparatus 31, passes through the base 2, and is converted into light in the scintillator layer 4. The converted light passes through the protection layer 5 and the passivation layer 6. The photoelectric conversion units 7 arranged on the substrate 8 then convert the light into electrical signals. In this manner, the radiation detection apparatus 31 detects radiation including information inside the body of the object.

In this case, each member 3 is disposed so as to gradually decrease in width from the upper surface to the lower surface. By taking this shape, the member 3 can prevent radiation from entering adjacent pixels and efficiently detect, in each pixel, light generated in the scintillator layer. As exemplified by FIG. 1A, the members 3 may be disposed to completely separate the scintillator layer 4 into portions. Alternatively, as exemplified by FIG. 1B, the members 3 may be disposed such that the scintillator layer 4 exists between the lower surfaces of the members 3 and the upper surface of the protection layer 5. In this case, it is preferable to dispose the members 3 so as to satisfy the conditions to be described later.

In this case, satisfying H_{X}>H_{S} where H_{S} is the height of the scintillator layer 4 and H_{X} is the height of the member 3 can form an air layer having a low refractive index between the scintillator layer 4 and the protection layer 5. This is an obstructive factor due to scattering of light and the like, and hence is not preferable. It is therefore preferable to provide the members 3 so as to satisfy H_{X}≦H_{S}. It is possible to select a material for the member 3 so as to satisfy the relationship of μ_{X}≧μ_{S} where μ_{X} is the linear attenuation coefficient of the member 3 and μ_{S} is the linear attenuation coefficient of the material forming the scintillator layer 4. The linear attenuation coefficients μ_{X} and μ_{S} represent indices how much the intensity (dose) of radiation attenuates when it passes through substances. For example, a radiation intensity I at a depth x of a substance can be expressed by I=I₀×exp(−μx_{X}) where I₀ is the intensity of radiation at the time of incidence (depth x=0). The linear attenuation coefficients μ_{X} and μ_{S} each can be obtained by multiplying the mass attenuation coefficient of a material and the density of the material. In addition, for the members 3, it is possible to select a material which does not emit (scintillation) so much light as at least the scintillator layer 4 (or emits light lower in amount than the scintillator layer 4) upon incidence of light.

For example, when the scintillator layer 4 is made of CsI:TI, μ_{S}=100.9. In this case, for the members 3, it is possible to use, for example, metallic materials such as Ir, Pt, Os, Au, Re, W, Pd, Rh, Ag, Ru, Hg, Ta, La, Tc, TL, Pb, Cd, Sn, Bi, In, Sb, Mo, Te, and Hf. When the scintillator layer 4 is made of Gd₂O₂S:Tb, μ_{S}=39.1. In this case, for the members 3, it is possible to use metallic materials such as Nb, Ba, Ra, Zr, Y, Cs, and Cu in addition to the above materials. Alternatively, when the scintillator layer 4 is made of CsI:TI, it is possible to use, for the member 3, metallic oxide materials such as SnO₂, SnO, PbO₂, Bi₂O₃, Pb₃O₄, PbO, BaO, and PtO. When the scintillator layer 4 is made of Gd₂O₂S:Tb, it is possible to use, for the member 3, metallic oxide materials such as SnO₄, Re₂O₇, RuO₂, ReO₃, MoO₂, Ta₂O₅, Sb₂O₃, BiO, WO₃, and ReO₂. Alternatively, an inorganic compound may be used for the member 3.

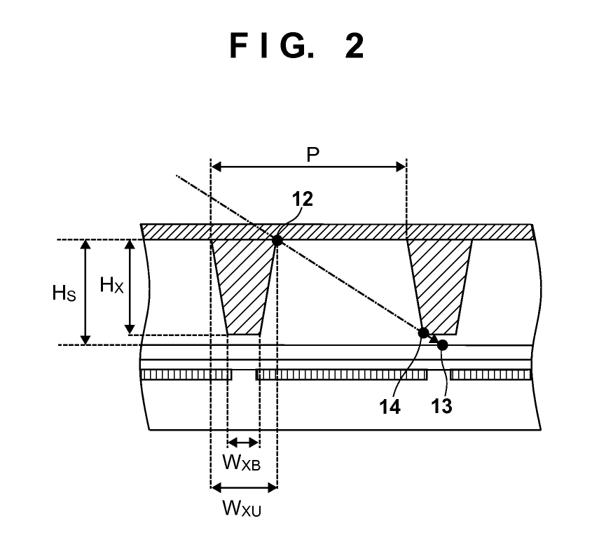

When radiation obliquely enters the region of a given pixel, as shown in FIG. 2, it is possible to prevent the radiation from propagating straight to the region of another pixel. That is, this radiation enters the members 3 disposed on the two sides of a pixel so as to propagate from an end 12 of the pixel at the upper surface of one member 3 to an end 14 of the pixel at the lower surface of the other member 3. At this time, a point 13 at which the radiation reaches the upper surface of the protection layer 5 should be located inside the region of the pixel. For example, this point should not exceed the intersection point between the central line of the member 3 and the upper surface of the protection layer 5. In this case, let P be the pitch of the array of a plurality of pixels, H_{S} be the height of the scintillator layer 4, H_{X} be the height of the member 3, W_{XU} be the width of the upper surface of the member 3, and W_{XB} be the width of the lower surface of the member 3. In this case, it is preferable to satisfy the relationship of (H_{X}/H_{X})≦((W_{XU}−2×P)/(W_{XB}+W_{XU}−2×P)).

In addition, letting P be the pitch of the array of a plurality of pixels and W_{XU} be the width of the upper surface of the member 3, it is preferable to provide members 3 so as to satisfy the relationship of W_{XU}≦P/4. This is because since the member 3 prevents the incidence of radiation, setting W_{XU}>P/4 will lead to a loss of a large amount of radiation including object information, resulting in a decrease in the sensitivity of the radiation detection apparatus 31.

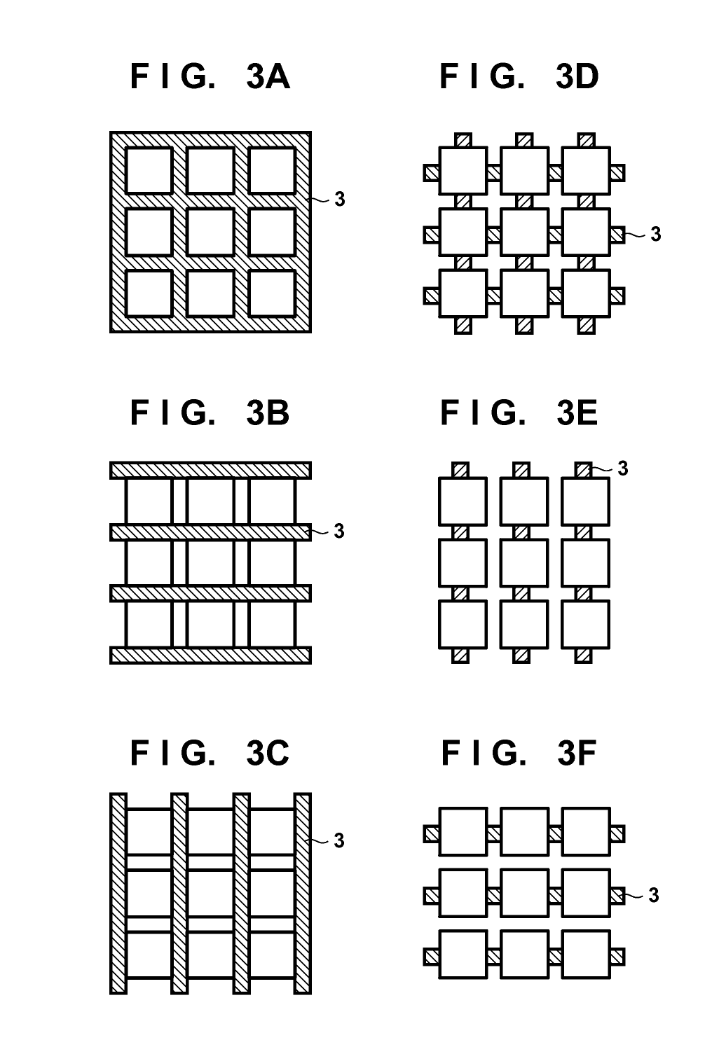

As exemplified by FIGS. 3A to 3F, it is possible to obtain the above effect by disposing the members 3 in both (FIG. 3A) or either (FIG. 3B or 3C) of the column and row directions of the pixel array. In addition, it is possible to obtain this effect by partially disposing the members 3 in both (FIG. 3D) or either (FIG. 3E or 3F) of the column and row directions of the pixel array.

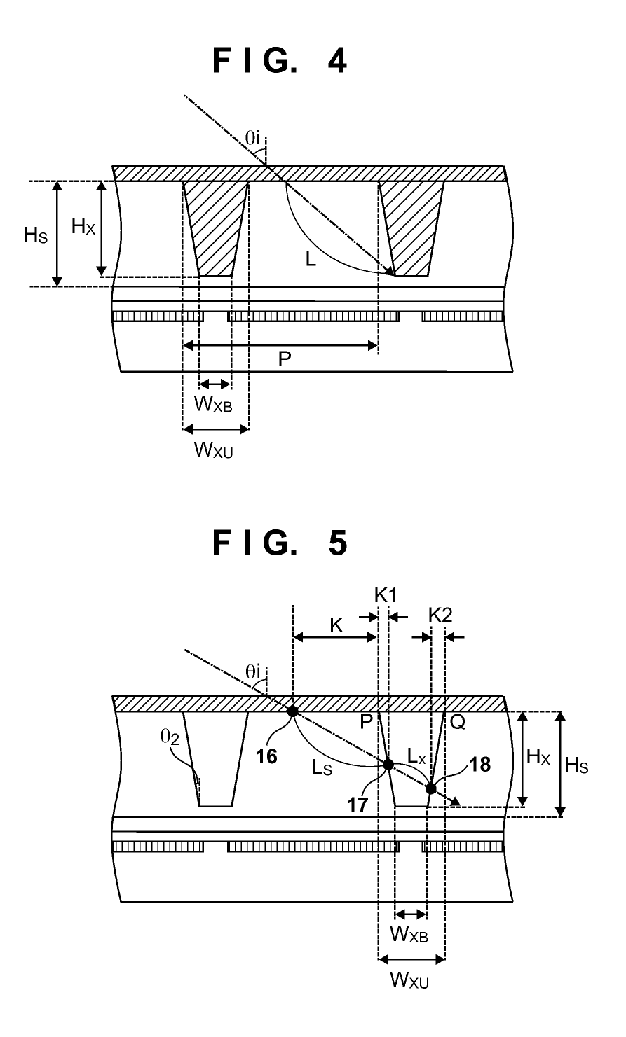

The radiation detection apparatus 31 will be further examined below. The height H_{X} of the member 3 will be examined first. Consider a case in which radiation with an intensity I₁₀ that enters from a position 10 at an incident angle θi reaches an end 11 of the lower surface of the member 3 through an optical path length L, as exemplified by FIG. 4. Referring to FIG. 4, let P be the pitch of the pixel array of a plurality of pixels, H_{S} be the height of the scintillator layer 4, H_{X} be the height of the member 3, W_{XU} be the width of the upper surface of the member 3, and W_{XB}, be the width of the lower surface of the member 3. At this time, L=H_{X}×sec θi (to be referred to as equation (1) hereinafter) is obtained from H_{X}=L×cos θi. Therefore, letting I₁₁ be the radiation intensity at the end 11 and μ_{S} be the linear attenuation coefficient of the scintillator, I₁₁/I₁₀=exp(−μ_{S}×L)=exp(−μ_{S}×H_{X}×sec θi) (to be referred to as equation (2) hereinafter) is obtained. According to equations (1) and (2), H_{X}=−(cos θi/μ_{S}) In(I₁₁/I₁₀) (to be referred to as equation (3) hereinafter) is obtained. When, for example, the scintillator layer 4 is made of CsI:TI (μ_{S}=100.9), H_{X}=198 μm may be set to attenuate the intensity of radiation (40 keV) with incident angle θi=30° to 1% at the end 11 according to equation (3). Likewise, when θi=45°, H_{X}=162 μm may be set; when θi=60°, H_{X}=115 μm; when θi=75°, H_{X}=60 μm; and when θi=89° (almost the maximum angle), H_{X}=4 μm. In this manner, it is possible to selectively provide the suitable height H_{X} of the member 3 in accordance with specifications.

The shape of the member 3 will be examined next. As exemplified in FIG. 5, radiation (with the incident angle θi) which has obliquely entered from a position 16 spaced apart from an end P of the upper surface of the member 3 by a distance K has reached a position 17 on a side surface of the member 3 in the scintillator through an optical path L_{S}. The radiation then has reached a position 18 on a side surface on the opposite side of the member 3 in the member 3 through an optical path L_{W}.

At this time, letting L_{S} be the lateral distance from the position 16 to the position 17 and K₁ be the distance from the end P of the upper surface of the member 3 to the position 17, L_{S}=(K+K₁)/sin θi (to be referred to as equation (4) hereinafter) is obtained. In addition, letting L_{X} be the distance from the position 17 to the position 18 and K₂ be the distance from the position 18 to an end Q of the upper surface of the member 3, L_{X}=(W_{XU}−K₁−K₂)/sin θi (to be referred to as equation (5) hereinafter) is obtained. A gradient O₂ of a side surface of the member 3 is calculated according to tan θ2=(W_{XU}−W_{XB})/(2×H_{X}) (to be referred to as equation (6) hereinafter). As is obvious from FIG. 5, θi and θ2 hold the relationship of cot θi=K₁/((K+K₁)×tan θ2) (to be referred to as equation (7) hereinafter). Therefore, according to equations (6) and (7), K₁=(K×(W_{XU}−W_{XB})×cot θi)/(2×H_{X}−((W_{XU}−W_{XB})×cot θi) (to be referred to as equation (8) hereinafter) is obtained. Thereafter, according to equations (4) and (8), L_{S}=(2×H_{X}×K×cot θi)/((2×H_{X}−(W_{XU}−W_{XB})×cot θi)×sin θi) (to be referred to as equation (9) hereinafter) is obtained.

Let μ_{X} and μ_{S} be the linear attenuation coefficients of the member 3 and scintillator layer 4, respectively, and I₂₆, I₂₇, and I₂₈ be the radiation intensities at the positions 16, 17, and 18, respectively. In this case, I₁₇/I₁₆=exp(−μ_{S}×L_{S}) and I₁₈/I₁₇=exp(−μ_{X}×_{X}). Therefore, I₁₈/I₁₆=exp(−μ_{S}×L_{S}×μ_{X}×_{X}). At the position 18, the radiation is completely absorbed, and I₂₈=0 may be obtained. According to equation (5), therefore, setting L_{T}≡L_{S}×L_{X} will obtain L_{T}=1/(μ_{S}×L_{S}×μ_{X})+L_{S} (to be referred to as equation (10) hereafter).

Consider x- and y-coordinates with the position 16 being an origin point and the x- and y-axes being set in the rightward and upward directions of FIG. 5. That is, assume that the first and second quadrants are located on the incident side of radiation, and the third and fourth quadrants are located on the opposite side. In this case, the coordinates of the position 18 are expressed by (x₁₈, y₁₈)=(L_{T}×sin θi, −L_{T}×cos θi) (to be referred to as equation (11) hereinafter). According to equations (9), (10), and (11), (x₁₈, y₁₈) is given below as follows: x₁₈=((2×H_{X}−(W_{XU}−W_{XB})×cot θi)/(2×μ_{S}×μ_{X}×H_{X}×K×cot θi))×sin² θi+2×H_{X}×K/(2×H_{X}×tan θi−W_{XU}+W_{XB}) (to be referred to as equation (12) hereinafter), and y₁₈=−((2×H_{X}−(W_{XU}−W_{XB})×cot θi)/(4×μ_{S}×μ_{X}×H_{X}×K×cot θi))×sin² θi−2×H_{X}×K/(2×H_{X}−(W_{XU}+W_{XB})×cot θi) (to be referred to as equation (13) hereinafter).

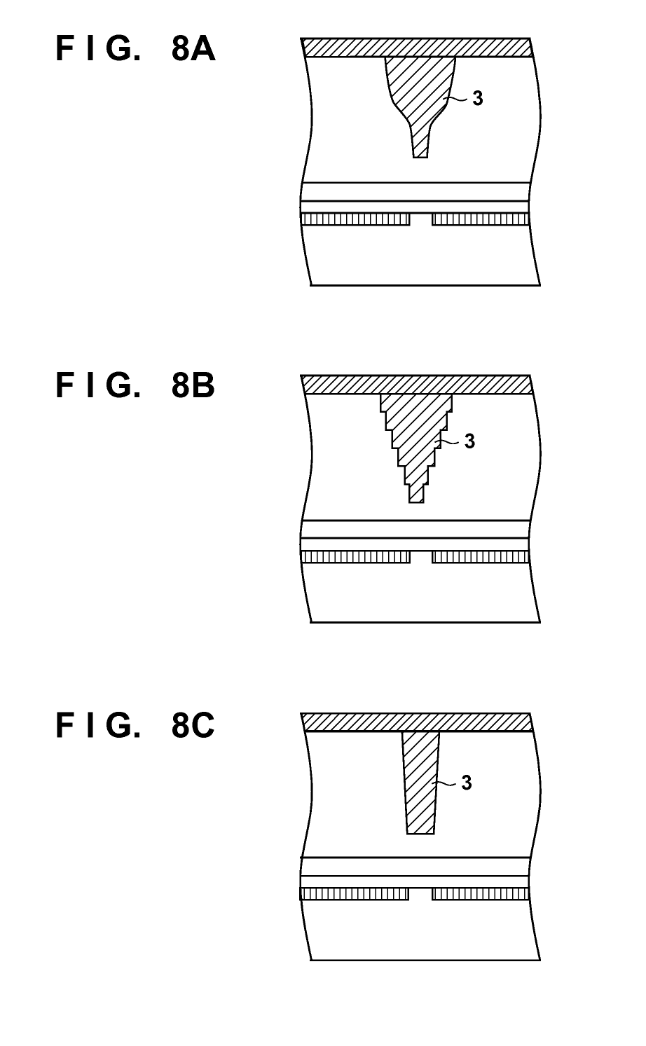

Therefore, the shape of the member 3 can be decided so as to be surrounded by the first locus drawn with the coordinates given by equations (12) and (13) when θi is changed from 0° to 180° and the second locus obtained by folding back the first locus on a central line (x=K+W_{XU}/2) of the member 3. If the intersection point between the first and second loci is located below the scintillator layer 4 (y₁₈<−H_{X}), the shape of the member 3 can be decided so as to be surrounded by y=−H_{X} in addition to the first and second loci. In addition, the first locus can be designed to approximate y=c×x⁵−d×x⁴+e×x³−f×x²+g×x−h (to be referred to as equation (14) hereinafter) where c, d, e, f, g, and h are positive variables. FIG. 8A shows an example of the shape of the member 3 which is determined by the loci given by equations (12) and (13).

In addition, the radiation detection apparatus 31 may further include a light reflection portion 50 disposed to cover the side surface of each member 3, as exemplified by FIG. 1C. This allows the light generated in the scintillator layer 4 to be efficiently reflected toward a sensor panel 40. This can improve the MTF. In this case, it is preferable to satisfy the relationship H_{S}≧H_{R}≧H_{X} where H_{S} is the height of the scintillator layer 4, H_{X} is the height of the member 3, and H_{R} is the height of the light reflection portion 50.

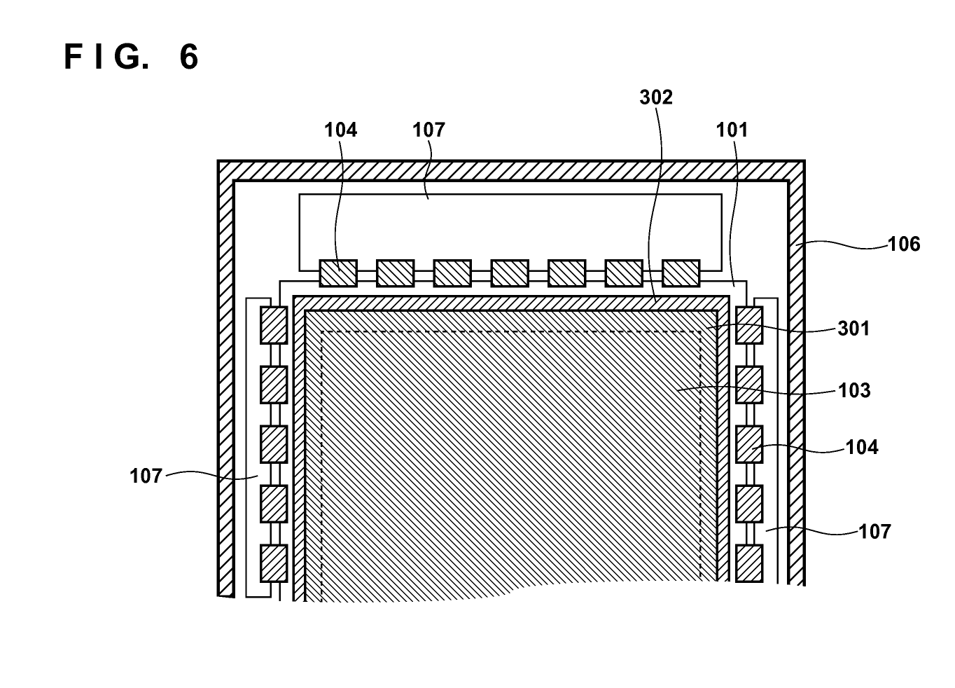

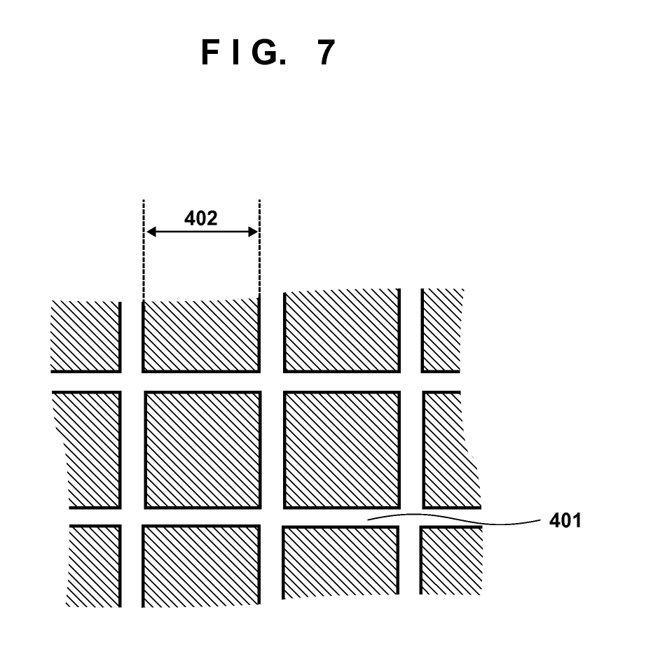

The effect of this embodiment will be examined below by comparison with Comparative Example 1. A radiation detection apparatus according to Comparative Example 1 will be described with reference to FIG. 6 before comparison. First of all, a thin semiconductor film made of amorphous silicon is formed on an alkali-free glass substrate. Photoelectric conversion units (including photoelectric conversion elements and TFTs) and wirings are provided on the thin semiconductor film. Each photoelectric conversion element has a size of 160 μm (P=160 μm) in both the x and y directions, and 2,208 pixels and 2,688 pixels are respectively formed in the x and y directions. Thereafter, an SiN layer as a protection layer and a polyimide resin layer are formed, thereby obtaining a sensor substrate 101.

For example, an aluminum substrate 301 is then prepared as a scintillator underlying layer. This makes the substrate 301 function as a reflection layer as well. A scintillator layer (thickness H_{S}=400 μm) was provided on the substrate 301 by vapor deposition while the deposition rates of CsI (cesium iodide) and TlI (thallium iodide) were separately controlled. A hot-melt resin containing polyolefin-based resin as a main component was transferred and bonded to a PET (polyethylene terephthalate) film, thereby forming a scintillator protection layer (thickness: 20 μm). The scintillator panel formed in this manner was bonded on the sensor substrate 101 by using an adhesive layer (thickness: about 25 μm) made of an acrylic adhesive agent, and a degassing process was performed to remove air from the bonded portion.

Subsequently, an epoxy-based resin was potted on the scintillator panel and a panel peripheral portion 302 and was thermally cured by a heating process (120° C. for about 30 min) to perform sealing, thereby obtaining a sensor panel. In addition, external wiring/surface-mount components 104 were mounted on the signal input/output units of the sensor panel. Finally, the sensor panel was provided with a housing 106 which protects the sensor panel, thereby forming a radiation detection apparatus according to Comparative Example 1.

An MTF evaluation method for comparison was performed in the following manner. First of all, the radiation detection apparatus was set on an evaluation apparatus, and a 20-mm Al filter for soft X-ray removal was set between the X-ray source and the apparatus.

The height between the substrate and the X-ray source was adjusted to 130 cm, and the radiation detection apparatus was connected to an electric driving system. In this state, a rectangular MTF chart was mounted on the radiation detection apparatus at a tilt angle of about 2° to 3°, and 50-ms X-ray pulses were applied to the apparatus six times under the condition of a tube voltage of 80 keV and a tube current of 250 mA. The MTF chart was removed. Likewise, X-ray pulses were then applied to the apparatus six times. MTF evaluation was performed by analyzing the images respectively obtained by using three of the six applications of X-ray pulses which exhibited stable doses. The MTF of the radiation detection apparatus according to Comparative Example 1 was 0.360 at 2 lp/mm. Likewise, a sensitivity evaluation method for comparison was performed by three applications of X-ray pulses under the above condition. The sensitivity of the radiation detection apparatus according to Comparative Example 1 measured by this method was 5,200 LSB.

The MTF and sensitivity evaluation results in this embodiment will be described next. A 120-μm DFR (Dry Film Resist) was laminated on a substrate under the same condition as that in Comparative Example 1. Thereafter, as exemplified by FIG. 7, a photomask having openings formed with a width of 40 μm at a pitch of 160 μm in the vertical and horizontal directions, and was exposed under the condition of 240 mJ/cm². Thereafter, the resultant structure was developed and sufficiently dried, thereby forming grooves (width: 40 μm, height: 120 μm) in which the members 3 were to be formed. This base was then set on a screen printer, which performed screen printing by using a Bi₂O₃ paste of about 500 mPa·s whose volume ratio of a resin component was adjusted to 4%. The particle size distribution median value of this Bi₂O₃ paste was about 1.0 μm according to measurement by a laser microtrack method. The screen printing was performed by using a patterned screen. This paste was sufficiently cast into the grooves in which the members 3 were to be formed, and leveling was sufficiently performed. This process was repeatedly executed until the DFR surface was totally covered. The resultant structure was then dried (at about 140° C.), and was polished until the members 3 had a height of 120 μm. The resultant structure was dipped in a peeling liquid to remove the DFR. This method could form the members 3 which were formed from Bi₂O₃ particles to have a width of 40 μm and a height of 120 μm. The above process was repeated by using a 30-μm wide opening mask to finally obtain a scintillator panel including the members 3 with H_{X}=240 μm, W_{XU}=40 μm, and W_{XB}=20 μm. Subsequently, as in Comparative Example 1, a scintillator layer (CsI:TI) was deposited by using the substrate on which the members 3 were formed. The resultant structure was polished to form the scintillator layer 4 having a thickness of 400 μm.

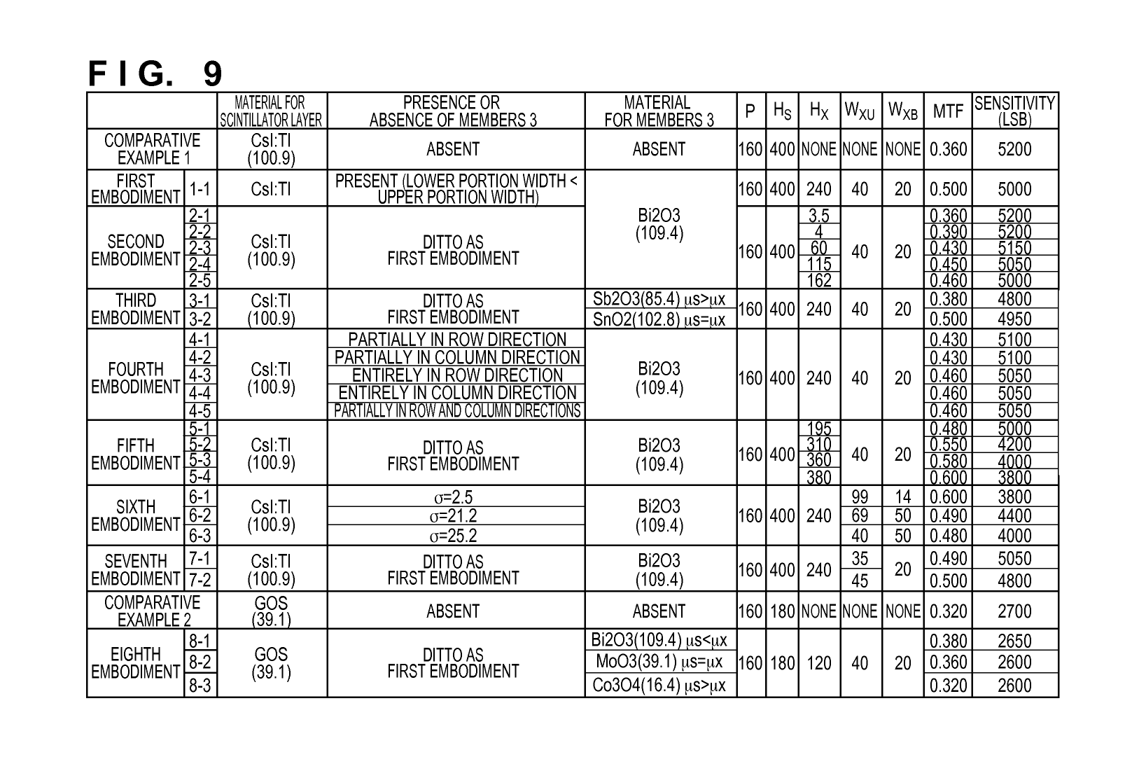

When the radiation detection apparatus 31 according to this embodiment, which was obtained in the above manner, was evaluated by the same method as in Comparative Example 1, the MTF was 0.500 and the sensitivity was 5,000 LSB. As is obvious from the comparison with the evaluation results in Comparative Example 1, the MTF of the radiation detection apparatus 31 could be improved while a loss of sensitivity was suppressed. FIG. 9 shows a comparative table including data concerning each embodiment and Comparative Example 2 to be described later in addition to the above embodiment and Comparative Example 1.

### Second Embodiment

In the second embodiment, radiation detection apparatuses 32 were obtained by the same method as in the first embodiment except that a parameter was assigned to a height H_{X} of members 3. More specifically, H_{X}=3.5, 4.0, 60, 115, and 162 μm.

After the radiation detection apparatuses 32 were manufactured, they were evaluated in the same manner as in the first embodiment. When H_{X}=3.5 μm, the MTF was 0.360, and the sensitivity was 5,200 LSB. When H_{X}=4.0 μm, the MTF was 0.390, and the sensitivity was 5,200 LSB. When H_{X}=60 μm, the MTF was 0.430, and the sensitivity was 5,150 LSB. When H_{X}=115 μm, the MTF was 0.450, and the sensitivity was 5,050 LSB. When H_{X}=162 μm, the MTF was 0.460, and the sensitivity was 5,000 LSB. As compared with Comparative Example 1, each radiation detection apparatus 32 can improve the MTF while suppressing a loss of sensitivity, when the height H_{X} of the member 3 is equal to or more than 4 μm, preferably equal to or more than 60 μm, or more preferably equal to or more than 115 μm.

### Third Embodiment

In the third embodiment, radiation detection apparatuses 33 were obtained by the same method as in the first embodiment except that the material for members 3 was changed. More specifically, first, a paste containing an Sb₂O₃ powder having an average particle size of 1 μm was used. Second, a paste containing an SnO₂ powder having an average particle size of 2 μm was used. A linear attenuation coefficient μ_{X1} (=85.4) of Sb₂O₂ is smaller than a linear attenuation coefficient μ_{S} (=100.9) of the scintillator layer 4 (CsI:TI). A linear attenuation coefficient μ_{X2} of SnO₂ is 102.8, which is almost equal to μ_{S}.

After the radiation detection apparatuses 33 were manufactured, the apparatus was evaluated in the same manner as in the first embodiment. When a paste containing an Sb₂O₂ powder having an average particle size of 1 μm was used, the MTF was 0.380, and the sensitivity was 4,800 LSB. When a paste containing an SnO₂ powder having an average particle size of 2 μm was used, the MTF was 0.500, and the sensitivity was 4,950 LSB. As compared with Comparative Example 1, each radiation detection apparatus 33 can improve the MTF while suppressing a loss of sensitivity, when the linear attenuation coefficient μ_{X} of the member 3 is equal to or more than the linear attenuation coefficient μ_{S} of the scintillator layer.

### Fourth Embodiment

In the fourth embodiment, radiation detection apparatuses 34 were obtained by the same method as in the first embodiment except that the layout positions of members 3 were changed. More specifically, the members 3 were arranged in five patterns as exemplified by FIGS. 3E, 3F, 3B, 3C, and 3D.

After the radiation detection apparatuses 34 were manufactured, the apparatuses were evaluated in the same manner as in the first embodiment. When the members 3 were arranged as exemplified by FIG. 3E, the MTF was 0.430, and the sensitivity was 5,100 LSB. When the members 3 were arranged as exemplified by FIG. 3F, the MTF was 0.430, and the sensitivity was 5,100 LSB. When the members 3 were arranged as exemplified by FIG. 3B, the MTF was 0.460, and the sensitivity was 5,050 LSB. When the members 3 were arranged as exemplified by FIG. 3C, the MTF was 0.460, and the sensitivity was 5,050 LSB. When the members 3 were arranged as exemplified by FIG. 3D, the MTF was 0.460, and the sensitivity was 5,050 LSB.

As described in the first embodiment, the effects of the present invention were obtained by arranging the members 3 in both the column and row directions of the pixel array (FIG. 3A). However, as is obvious from this embodiment, the members 3 may be arranged in one of the column and row directions of the pixel array (FIG. 3B or 3C) or may be partially arranged in both the column and row directions (FIG. 3D) or one of the column and row directions (FIG. 3E or 3F). In this manner, each radiation detection apparatus 34 can improve the MTF while suppressing a loss of sensitivity.

### Fifth Embodiment

In the fifth embodiment, radiation detection apparatuses 35 were obtained by the same method as in the first embodiment except that the shape of each member 3 was changed. More specifically, first, each member 3 was formed in conformity with W_{XU}=40 μm, W_{XB}=40 μm, and H_{X}=195 μm. Second, each member 3 was formed in conformity with W_{XU}=40 μm, W_{XB}=40 μm, and H_{X}=310 μm. Third, each member 3 was formed in conformity with W_{XU}=40 μm, W_{XB}=40 μm, and H_{X}=360 μm. Fourth, each member 3 was formed in conformity with W_{XU}=40 μm, W_{XB}=40 μm, and H_{X}=380 μm. These members were formed by using a DFR having a thickness of 120 μm and repeating exposure using a photomask having openings formed with a width of 40 μm at a pitch of 160 μm in the vertical and horizontal directions, as exemplified by FIG. 7.

After the radiation detection apparatuses were manufactured, the apparatuses were evaluated in the same manner as in the first embodiment. When each member 3 had a shape conforming with W_{XU}=40 μm, W_{XB}=40 μm, and H_{X}=195 μm, the MTF was 0.480, and the sensitivity was 5,000 LSB. When each member 3 had a shape conforming with W_{XU}=40 μm, W_{XB}=40 μm, and H_{X}=310 μm, the MTF was 0.550, and the sensitivity was 4,200 LSB. When each member 3 had a shape conforming with W_{XU}=40 μm, W_{XB}=40 μm, and H_{X}=360 μm, the MTF was 0.580, and the sensitivity was 4,000 LSB. When each member 3 had a shape conforming with W_{XU}=40 μm, W_{XB}=40 μm, and H_{X}=380 μm, the MTF was 0.600, and the sensitivity was 3,800 LSB. According to the above results, therefore, there is obviously a tendency that it is preferable to arrange the members 3 so as to satisfy the relationship of (H_{S}/H_{X})≦((W_{XU}−2×p)/(W_{XB}+W_{XU}−2×P)).

### Sixth Embodiment

In the sixth embodiment, radiation detection apparatuses 36 were obtained by the same method as in the first embodiment except that the shape of each member 3 was changed. More specifically, first, each member 3 was formed to have a stepped shape in conformity with W_{XU}=99 μm, W_{XB}=14 μm, and H_{X}=120 μm, as exemplified by FIG. 8B. This shape was formed by repeating exposure using a 40-μm DFR. An opening width 401 of the photomask used in each of the repetitive exposure operations, which is exemplified by FIG. 7, was decreased to 100 μm, 80 μm, 60 μm, 40 μm, 20 μm, and 10 μm, thereby obtaining the members 3. When a side surface shape of a substrate formed under the same conditions was measured by processing an SEM observation image of a section of the substrate, σ of the side surface shape was 2.5. Second, as exemplified by FIG. 8C, the rectangular members 3 were formed, each conforming with W_{XU}=60 μm, W_{XB}=50 μm, and H_{X}=120 μm. As in the case of the first shape described above, this shape was obtained by using a photomask having an opening width 401 of 60 μm. In this case, σ of the side surface shape was 21.2. Third, the trapezoidal members 3 were formed, each conforming with W_{XU}=40 μm, W_{XB}=50 μm, and H_{X}=120 μm, by the same method. In this case, σ of the side surface shape was 25.2.

After the radiation detection apparatuses 36 were manufactured, the apparatuses were evaluated in the same manner as in the first embodiment. When the member 3 had the first stepped shape (W_{XU}=99 μm, W_{XB}=14 μm, and H_{X}=120 μm), the MTF was 0.600, and the sensitivity was 3,800 SLB. When the member 3 had the second rectangular shape (W_{XU}=60 μm, W_{XB}=50 μm, and H_{X}=120 μm), the MTF was 0.490, and the sensitivity was 4,400 LSB. When the member 3 had the third trapezoidal shape (W_{XU}=40 μm, W_{XB}=50 μm, and H_{X}=120 μm), the MTF was 0.480, and the sensitivity was 4,000 LSB. As described above, when σ of the side surface shape is 20 or more, each radiation detection apparatus 36 can improve the MTF while suppressing a loss of sensitivity.

### Seventh Embodiment

In the seventh embodiment, radiation detection apparatuses 37 were obtained by the same method as in the first embodiment except that the relationship between a width W_{XU} of each member 3 and a pitch P of pixels was changed. More specifically, first, each member 3 was formed in conformity with W_{XU}=35 μm, W_{XB}=20 μm, and H_{X}=240 μm by the same method as described above. In this case, W_{XU}/P=0.228. Second, each member 3 was formed in conformity with W_{XU}=45 μm, W_{XB}=20 μm, and H_{X}=240 μm by the same method as described above. In this case, W_{XU}/P=0.281.

After the radiation detection apparatuses 37 were manufactured, the apparatuses were evaluated in the same manner as in the first embodiment. When the members 3 were formed in conformity with W_{XU}=35 μm, W_{XB}=20 μm, and H_{X}=240 μm, the MTF was 0.490, and the sensitivity was 5,050 LSB. When the members 3 were formed in conformity with W_{XU}=45 μm, W_{XB}=20 μm, and H_{X}=240 μm, the MTF was 0.500, and the sensitivity was 4,800 LSB. According to the above results, therefore, there is obviously a tendency that it is preferable to arrange the members 3 so as to satisfy the relationship of W_{XU}≦P/4.

### Eighth Embodiment

A radiation detection apparatus according to Comparative Example 2 will be described with reference to FIG. 6 before a description of the eighth embodiment. In Comparative Example 2, a sensor substrate 101 was obtained by the same method as described above using a Gd₂O₂S:Tb scintillator powder for a scintillator layer. A substrate 301 was set on a screen printer, and a SUS 100 mesh screen was set with a clearance of 2.5 mm. A high-viscosity scintillator paste having a rotational viscosity of about 350 Pa·s at 0.3 rpm was formed by adding a vehicle (120 g) to a Gd₂O₂S:Tb scintillator (1 kg) having a particle size distribution median value of about 6 μm and mixing the material by using a planetary mixing apparatus. Screen printing was performed on the substrate 301 at a printing pressure of 0.2 MPa by using this paste. Leveling (about 30 min) was then performed on the substrate 301 after printing, and dried (at 120° C. for about 30 min). Thereafter, the scintillator layer 4 having a thickness of about 60 μm was obtained. Finally, the scintillator layer 4 having a thickness of about 180 μm was formed by repeating this screen printing three times.

An acrylic adhesive agent was applied to the substrate 301 to a thickness of about 10 μm, and the sensor substrate 101 was bonded on the substrate 301. As a scintillator protection layer to be formed on the substrate 301 on which the scintillator layer 4 was formed, a film obtained by transferring and bonding a hot-melt resin containing a polyolefin-based resin as a main component onto a 20-μm thick PET film was used. Subsequently, an epoxy-based resin was potted on the scintillator panel and a panel peripheral portion 302 and was thermally cured by a heating process (120° C. for about 30 min) to perform sealing, thereby obtaining a sensor panel.

In addition, external wiring/surface-mount components 104 were mounted on the signal input/output units of the sensor panel. Finally, the sensor panel was provided with a housing 106 which protects the sensor panel, thereby forming a radiation detection apparatus according to Comparative Example 2. When the MTF and sensitivity of this panel were evaluated, the MTF was 0.320, and the sensitivity was 2,700 LSB.

In the eighth embodiment to be described below, radiation detection apparatuses 38 were obtained under the same conditions as those in Comparative Example 2 except that members 3 were formed by using several different materials. More specifically, first, Bi₂O₃ was used for the members 3. Second, MoO₃ was used for the members 3. Third, Co₃O₄ was used for the members 3.

For example, the first (Bi₂O₃) members 3 were obtained as follows. First of all, a 120-μm thick DFR was laminated on a substrate formed under the same conditions as those in Comparative Example 2. Thereafter, as exemplified by FIG. 7, a photomask having openings formed with a width of 40 μm at a pitch of 160 μm in the vertical and horizontal directions was set and exposed under the condition of 240 mJ/cm². Thereafter, the resultant structure was developed and sufficiently dried, thereby forming grooves (width: 40 μm, height: 120 μm) in which the members 3 were to be formed. This base was then set on a screen printer, which performed screen printing by using a Bi₂O₃ paste of about 500 mPa·s whose volume ratio of a resin component was adjusted to 4%. The particle size distribution median value of this Bi₂O₃ paste was about 1.0 μm according to measurement by a laser microtrack method.

The screen printing was performed by using a patterned screen. This paste was sufficiently cast into the grooves in which the members 3 were to be formed, and leveling was sufficiently performed. This process was repeatedly executed until the DFR surface was totally covered. The resultant structure was then dried (at about 140° C.), and was polished until the members 3 had a height of 120 μm. The resultant structure was dipped in a peeling liquid to remove the DFR. This method could form the members 3 which were formed from Bi₂O₃ particles to have a width of 40 μm and a height of 120 μm. The above process was repeated by using a 30-μm wide opening mask to finally obtain a scintillator panel including the members 3 with H_{X}=120 μm, W_{XU}=40 μm, and W_{XB}=20 μm. Subsequently, as in Comparative Example 2, a scintillator layer (Gd₂O₂S:Tb) was deposited by using the substrate on which the members 3 were formed. The resultant structure was polished to form the scintillator layer 4 having a thickness of 400 μm.

After the radiation detection apparatuses 38 were manufactured in the above manner, the MTF and sensitivity of each apparatus were evaluated by the same method as described above. In the case of the first members 3, a linear attenuation coefficient μ_{X1} (=109.4) is larger than a linear attenuation coefficient μ_{S} (=39.1) of the scintillator layer 4 (Gd₂O₂S:Tb). In addition, in the case of the second members 3 (using a paste containing an MoO₃ powder having an average particle size of 1 μm), a linear attenuation coefficient μ_{X2} (=39.1) is equal to μ_{S}. In addition, in the case of the third members 3 (using a paste containing a Co₃O₄ powder having an average particle size of 1 μm), a linear attenuation coefficient μ_{X3} (=16.4) is smaller than μ_{S}.

In the case of the first members 3 (using Bi₂O₃), the MTF was 0.380, and the sensitivity was 2,650 LSB. In the case of the second members 3 (using MoO₃), the MTF was 0.360, and the sensitivity was 2,600 LSB. In the third members 3 (using Co₃O₄), the MTF was 0.320, and the sensitivity was 2,600 LSB. As compared with Comparative Example 2, each radiation detection apparatus 38 can improve the MTF while suppressing a loss of sensitivity when the linear attenuation coefficient μ_{X} of the members 3 is equal to or more than the linear attenuation coefficient μ_{S} of the scintillator layer.

Although the respective embodiments have been described above, the present invention is not limited to them. Obviously, the object, state, application, function, and other specifications of the present invention can be changed as needed, and the present invention can be implemented by other embodiments. In addition, the radiation detection apparatuses 31 to 38 can be applied to radiation imaging systems. For example, the radiation (typically X-rays) emitted from a radiation source is transmitted through an object, and the radiation detection apparatuses 31 to 38 can detect the radiation containing information inside the object. For example, a signal processing unit performs predetermined processing of the information obtained by this operation. This unit transfers the resultant image signal to a display unit such as a display unit, which can display the corresponding image.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-289889, filed Dec. 28, 2011, which is hereby incorporated by reference herein in its entirety.

What is claimed is:

1. A radiation detection apparatus including a sensor panel which includes a plurality of pixels two-dimensionally arranged on a substrate and detects light, and a scintillator layer which is disposed on the sensor panel and converts radiation into light, the apparatus comprising
members embedded in regions between the plurality of pixels in the scintillator layer,
wherein said member satisfies a relationship of μ_{X}≧μ_{S} where μ_{X} is a linear attenuation coefficient of said member and μ_{S} is a linear attenuation coefficient of a material forming the scintillator layer, contains a material whose light emission amount is smaller than that of the scintillator layer when the radiation enters, and gradually decreases in width from an upper surface to a lower surface.

2. The apparatus according to claim 1, wherein letting P be a pitch of an array of the plurality of pixels, H_{S} be a height of the scintillator layer, H_{X} be a height of said member, W_{XU} be a width of the upper surface of said member, and W_{XB}, be a width of the lower surface of said member,
a relationship of (H_{S}/H_{X})≦((W_{XU}−2×P)/(W_{XB}+W_{XU}−2×P)) holds.

3. The apparatus according to claim 1, wherein letting P be a pitch of the pixels and W_{XU} be a width of the upper surface of said member, W_{XU}≦P/4 holds.

4. The apparatus according to claim 1, wherein in x-y coordinates in which a point spaced apart from said member on an upper surface of the scintillator layer by a distance K is an origin point, a first quadrant and a second quadrant are located on an incident side of radiation, and a third quadrant and a fourth quadrant are located on an opposite side,
letting P be the pitch of the array of the plurality of pixels, H_{S} be the height of the scintillator layer, H_{X} be the height of said member, W_{XU} be the width of the upper surface of said member, W_{XB} be the width of the lower surface of said member, and θi is an incident angle at which the radiation passes through the origin point and enters the fourth quadrant from the second quadrant,
if
x=((2×H_{X}−((W_{XU}−W_{XB})×cot θi)/(2×μ_{S}×μ_{X}×H_{X}×K×cot θi))×sin² θi+2×H_{X}×K/(2×H_{X}×tan θi−W_{XU}+W_{XB}),
y=−((2×H_{X}−(W_{XU}−W_{XB})×cot θi)/(4×μ_{S}×μ_{X}×H_{X}×K×cot θi))×sin² θi−2×H_{X}×K/(2×H_{X}−(W_{XU}+W_{XB})×cot θi), then
said member has a shape surrounded by a first locus drawn with (x, y) when θi is changed from 0° to 180° and a second locus obtained by folding back the first locus on x=K+W_{XU}/2, when y≧−H_{X}, and has a shape surrounded by y=−H_{X} in addition to the first locus and the second locus, when y<−H_{X}.

5. The apparatus according to claim 1, further comprising a light reflection unit which is disposed to cover a side surface of said member and reflects light,
wherein letting H_{S} be the height of the scintillator layer, H_{X} be the height of said member, and H_{R} be a height of said light reflection unit,
a relationship of H_{S}≧H_{R}≧H_{X} holds.

6. A radiation imaging system comprising:
a radiation detection apparatus defined in claim 1;
a signal processing unit which processes a signal from said radiation imaging apparatus;
a display unit which displays a signal from said signal processing unit; and
a radiation source which generates the radiation.
